(19) United States
(12) Patent Application Publication
(10) Pub. No.: US 2024/0389001 A1
(43) Pub. Date: Nov. 21, 2024

(54) UE OPERATION METHOD RELATED TO SIB IN WIRELESS COMMUNICATION SYSTEM

(71) Applicant: LG Electronics Inc., Seoul (KR)

(72) Inventors: Seoyoung BACK, Seoul (KR); Giwon PARK, Seoul (KR); Hanbyul SEO, Seoul (KR); Seungmin LEE, Seoul (KR); Jongwoo HONG, Seoul (KR)

(21) Appl. No.: 18/579,241

(22) PCT Filed: Jul. 13, 2022
(86) PCT No.: PCT/KR2022/010193

§ 371 Date: Jan. 12, 2024

(30) Foreign Application Priority Data
Jul. 13, 2021 (KR) 10-2021-0091875

(51) Int. Cl. H04W 48/12; H04W 40/02; H04W 88/04; H04W 92/18

(52) U.S. Cl. CPC H04W 48/12; H04W 40/02; H04W 88/04; H04W 92/18

(57) ABSTRACT

An embodiment relates to an operation method of a remote user equipment (UE) in a wireless communication system, the method comprising: selecting a plurality of candidate relay UEs by the remote UE; selecting, by the remote UE, one relay UE from among the plurality of candidate relay UEs on the basis of a measurement result; establishing a sidelink connection with the relay UE by the remote UE; and transmitting, by the remote UE, a system information block (SIB)-related request including an SIB type to the relay UE, wherein the remote UE receives a message related to the non-support of the SIB type from the relay UE on the basis of the SIB type being out of the capability of the relay UE.

### TECHNICAL FIELD

The present disclosure relates to a wireless communication system and, more particularly, to a method and apparatus for transmitting and receiving a system information block (SIB) when the capability of a relay user equipment (UE) is different from the capability of a remote UE in sidelink communication.

### BACKGROUND

Wireless communication systems are being widely deployed to provide various types of communication services such as voice and data. In general, a wireless communication system is a multiple access system capable of supporting communication with multiple users by sharing available system resources (bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system, and a multi carrier frequency division multiple access (MC-FDMA) system.

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars, and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability, and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

FIG. 1 is a diagram illustrating V2X communication based on pre-NR RAT and V2X communication based on NR in comparison.

For V2X communication, a technique of providing safety service based on V2X messages such as basic safety message (BSM), cooperative awareness message (CAM), and decentralized environmental notification message (DENM) was mainly discussed in the pre-NR RAT. The V2X message may include location information, dynamic information, and attribute information. For example, a UE may transmit a CAM of a periodic message type and/or a DENM of an event-triggered type to another UE.

For example, the CAM may include basic vehicle information including dynamic state information such as a direction and a speed, vehicle static data such as dimensions, an external lighting state, path details, and so on. For example, the UE may broadcast the CAM which may have a latency less than 100 ms. For example, when an unexpected incident occurs, such as breakage or an accident of a vehicle, the UE may generate the DENM and transmit the DENM to another UE. For example, all vehicles within the transmission range of the UE may receive the CAM and/or the DENM. In this case, the DENM may have priority over the CAM.

In relation to V2X communication, various V2X scenarios are presented in NR. For example, the V2X scenarios include vehicle platooning, advanced driving, extended sensors, and remote driving.

For example, vehicles may be dynamically grouped and travel together based on vehicle platooning. For example, to perform platoon operations based on vehicle platooning, the vehicles of the group may receive periodic data from a leading vehicle. For example, the vehicles of the group may widen or narrow their gaps based on the periodic data.

For example, a vehicle may be semi-automated or full-automated based on advanced driving. For example, each vehicle may adjust a trajectory or maneuvering based on data obtained from a nearby vehicle and/or a nearby logical entity. For example, each vehicle may also share a dividing intention with nearby vehicles.

Based on extended sensors, for example, raw or processed data obtained through local sensor or live video data may be exchanged between vehicles, logical entities, terminals of pedestrians and/or V2X application servers. Accordingly, a vehicle may perceive an advanced environment relative to an environment perceivable by its sensor.

Based on remote driving, for example, a remote driver or a V2X application may operate or control a remote vehicle on behalf of a person incapable of driving or in a dangerous environment. For example, when a path may be predicted as in public transportation, cloud computing-based driving may be used in operating or controlling the remote vehicle. For example, access to a cloud-based back-end service platform may also be used for remote driving.

A scheme of specifying service requirements for various V2X scenarios including vehicle platooning, advanced driving, extended sensors, and remote driving is under discussion in NR-based V2X communication.

### DISCLOSURE

### Technical Problem

Embodiment(s) are to provide a method of transmitting and receiving a system information block (SIB) when the capability of a relay user equipment (UE) is different from the capability of a remote UE in sidelink communication.

### Technical Solution

In an aspect of the present disclosure, provided herein is a method of operating a remote user equipment (UE) in a wireless communication system. The method may include: selecting, by the remote UE, a plurality of candidate relay UEs; selecting, by the remote UE, one relay UE among the plurality of candidate relay UEs based on measurement results; establishing, by the remote UE, a sidelink connection with the relay UE; and transmitting, by the remote UE, a system information block related (SIB-related) request including an SIB type to the relay UE. Based on that the SIB type is beyond a capability of the relay UE, the remote UE may receive a message related to inability to support the SIB type from the relay UE.

In an aspect of the present disclosure, provided herein is a remote UE in a wireless communication system. The remote UE may include: at least one processor; and at least one computer memory operably connected to the at least one processor and configured to store instructions that, when executed, cause the at least one processor to perform operations. The operations may include: selecting a plurality of candidate relay UEs; selecting one relay UE among the plurality of candidate relay UEs based on measurement results; establishing a sidelink connection with the relay UE; and transmitting an SIB-related request including an SIB type to the relay UE. Based on that the SIB type is beyond a capability of the relay UE, the remote UE may receive a message related to inability to support the SIB type from the relay UE.

In an aspect of the present disclosure, provided herein is a processor configured to perform operations for a remote UE in a wireless communication system. The operations may include: selecting a plurality of candidate relay UEs; selecting one relay UE among the plurality of candidate relay UEs based on measurement results; establishing a sidelink connection with the relay UE; and transmitting an SIB-related request including an SIB type to the relay UE. Based on that the SIB type is beyond a capability of the relay UE, the remote UE may receive a message related to inability to support the SIB type from the relay UE.

In a further aspect of the present disclosure, provided herein is a non-volatile computer-readable storage medium configured to store at least one computer program comprising instructions that, when executed by at least one processor, cause the at least one processor to perform operations for a remote UE. The operations may include: selecting a plurality of candidate relay UEs; selecting one relay UE among the plurality of candidate relay UEs based on measurement results; establishing a sidelink connection with the relay UE; and transmitting an SIB-related request including an SIB type to the relay UE. Based on that the SIB type is beyond a capability of the relay UE, the remote UE may receive a message related to inability to support the SIB type from the relay UE.

Based on the reception of the message related to the inability to support the SIB type, the remote UE may perform either relay reselection or SIB reception from a base station (BS), depending on whether the remote UE is located in coverage of a serving cell.

Based on that the remote UE is located out of coverage of a serving cell, the remote UE may perform relay reselection.

Based on that the remote UE is located in coverage of a serving cell, the remote UE may directly receive an SIB corresponding to the SIB-related request from a BS.

A serving cell of the remote UE may correspond to a serving cell of the relay UE.

The remote UE may obtain the capability of the relay UE from a discovery message transmitted by the relay UE.

The inability to support the SIB type may be based on that the capability of the relay UE is different from a capability of the remote UE.

The SIB type beyond the capability of the relay UE may correspond to one of the following cases: the remote UE is capable of supporting multimedia broadcast multicast services (MBMS), but the relay UE is incapable of supporting the MBMS; the remote UE is capable of supporting positioning services, but the relay UE is incapable of supporting the positioning services; and the remote UE has a standard specification release version higher than the relay UE.

The SIB type may correspond to one of positioning SIB types.

The remote UE may communicate with at least one of another UE, a UE related to an autonomous vehicle, a BS, or a network.

### Advantageous Effects

According to an embodiment, when the capability of a relay user equipment (UE) is different from the capability of a relay UE, and more particularly, even when the relay UE is incapable of supporting system information blocks (SIBs), the remote UE may receive a required SIB.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram comparing vehicle-to-everything (V2X) communication based on pre-new radio access technology (pre-NR) with V2X communication based on NR;

FIG. 2 is a diagram illustrating the structure of a long term evolution (LTE) system according to an embodiment of the present disclosure;

FIG. 3 is a diagram illustrating user-plane and control-plane radio protocol architectures according to an embodiment of the present disclosure;

FIG. 4 is a diagram illustrating the structure of an NR system according to an embodiment of the present disclosure;

FIG. 5 is a diagram illustrating functional split between a next generation radio access network (NG-RAN) and a 5th generation core network (5GC) according to an embodiment of the present disclosure;

FIG. 6 is a diagram illustrating the structure of an NR radio frame to which embodiment(s) of the present disclosure is applicable;

FIG. 7 is a diagram illustrating a slot structure of an NR frame according to an embodiment of the present disclosure;

FIG. 8 is a diagram illustrating radio protocol architectures for sidelink (SL) communication according to an embodiment of the present disclosure;

FIG. 9 is a diagram illustrating radio protocol architectures for SL communication according to an embodiment of the present disclosure;

FIG. 10 is a diagram illustrating a procedure for performing V2X or SL communication by a UE according to a transmission mode;

FIG. 11 and FIG. 12 are diagrams to describe embodiment(s); and

FIGS. 13 to 19 are diagrams illustrating various devices to which embodiment(s) are applicable.

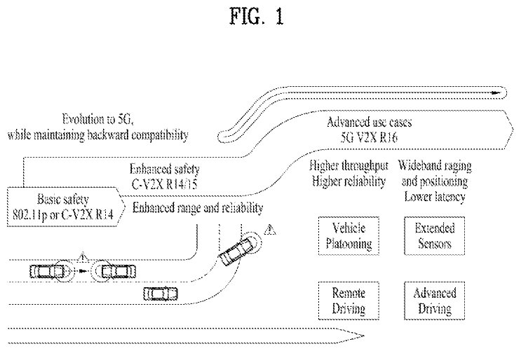

### DETAILED DESCRIPTION

In various embodiments of the present disclosure, “/” and “,” should be interpreted as “and/or.” For example, “A/B” may mean “A and/or B.” Further, “A, B” may mean “A and/or B.” Further, “A/B/C” may mean “at least one of A, B and/or C.” Further, “A, B, C” may mean “at least one of A, B and/or C.”

In various embodiments of the present disclosure, “or” should be interpreted as “and/or.” For example, “A or B” may include “only A,” “only B,” and/or “both A and B.” In other words, “or” should be interpreted as “additionally or alternatively.”

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHZ, an intermediate frequency band between 1 GHz and 10 GHz, and a high frequency (millimeter) band of 24 GHz or above.

While the following description is given mainly in the context of LTE-A or 5G NR for the clarity of description, the technical idea of an embodiment of the present disclosure is not limited thereto.

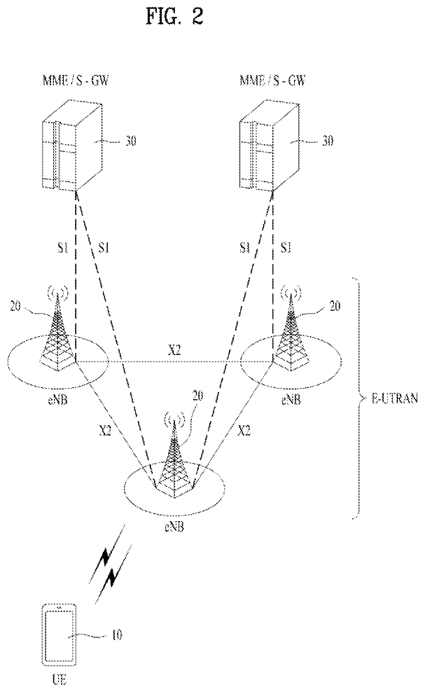

FIG. 2 illustrates the structure of an LTE system according to an embodiment of the present disclosure. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

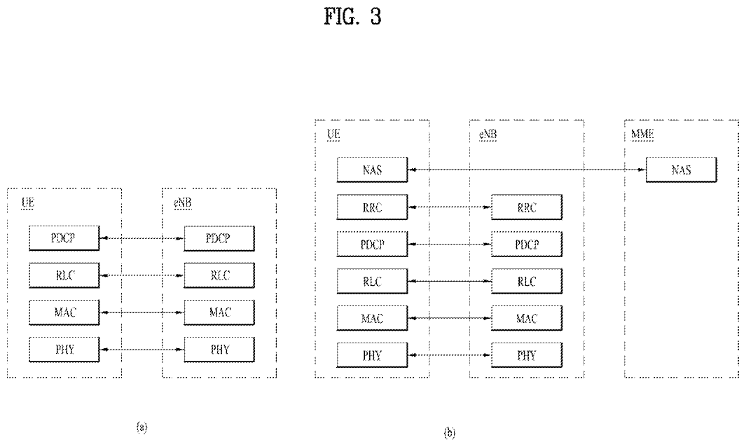

FIG. 3(a) illustrates a user-plane radio protocol architecture according to an embodiment of the disclosure.

FIG. 3(b) illustrates a control-plane radio protocol architecture according to an embodiment of the disclosure. A user plane is a protocol stack for user data transmission, and a control plane is a protocol stack for control signal transmission.

Referring to FIGS. 3(a) and 3(b), the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QOS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbol in the time domain by a plurality of subcarriers in the frequency domain. One subframe includes a plurality of OFDM symbols in the time domain. An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

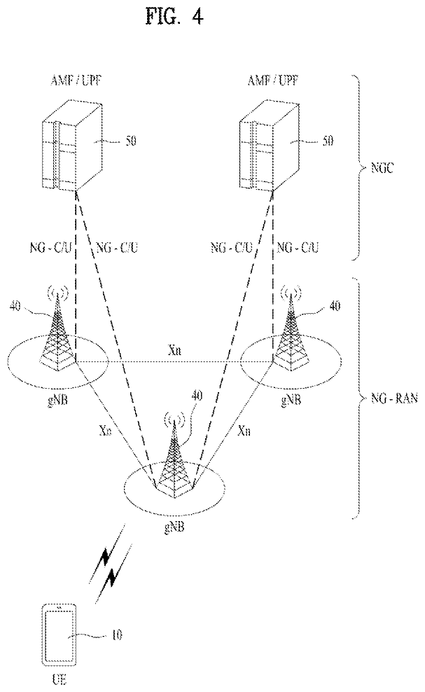

FIG. 4 illustrates the structure of an NR system according to an embodiment of the present disclosure.

Referring to FIG. 4, a next generation radio access network (NG-RAN) may include a next generation Node B (gNB) and/or an eNB, which provides user-plane and control-plane protocol termination to a UE. In FIG. 4, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

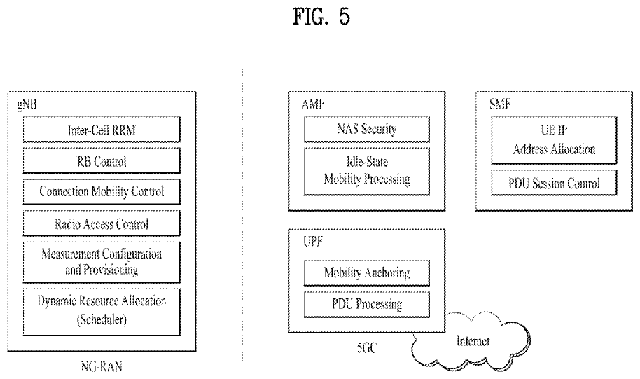

FIG. 5 illustrates functional split between the NG-RAN and the 5GC according to an embodiment of the present disclosure.

Referring to FIG. 5, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

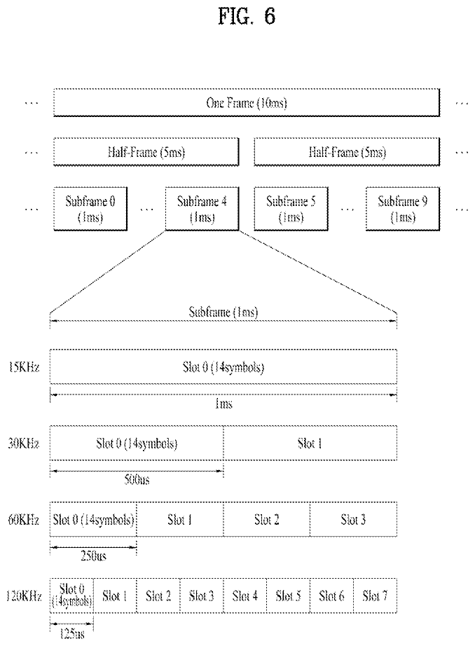

FIG. 6 illustrates a radio frame structure in NR, to which embodiment(s) of the present disclosure is applicable.

Referring to FIG. 6, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot Nslotsymb, the number of slots per frame Nframe,uslot, and the number of slots per subframe Nsubframe,uslot according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM (A) numerologies (e.g., SCSs, CP lengths, and so on) may be configured for a plurality of cells aggregated for one UE. Accordingly, the (absolute time) duration of a time resource including the same number of symbols (e.g., a subframe, slot, or TTI) (collectively referred to as a time unit (TU) for convenience) may be configured to be different for the aggregated cells.

In NR, various numerologies or SCSs may be supported to support various 5G services. For example, with an SCS of 15 kHz, a wide area in traditional cellular bands may be supported, while with an SCS of 30/60 kHz, a dense urban area, a lower latency, and a wide carrier bandwidth may be supported. With an SCS of 60 kHz or higher, a bandwidth larger than 24.25 GHz may be supported to overcome phase noise.

An NR frequency band may be defined by two types of frequency ranges, FR1 and FR2. The numerals in each frequency range may be changed. For example, the two types of frequency ranges may be given in [Table 3]. In the NR system, FR1 may be a “sub 6 GHz range” and FR2 may be an “above 6 GHz range” called millimeter wave (mmW).

TABLE 3

| Frequency Range | Corresponding | |
|---|---|---|
| designation | frequency range | Subcarrier Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerals in a frequency range may be changed in the NR system. For example, FR1 may range from 410 MHz to 7125 MHz as listed in [Table 4]. That is, FR1 may include a frequency band of 6 GHz (or 5850, 5900, and 5925 MHz) or above. For example, the frequency band of 6 GHz (or 5850, 5900, and 5925 MHz) or above may include an unlicensed band. The unlicensed band may be used for various purposes, for example, vehicle communication (e.g., autonomous driving).

TABLE 4

| Frequency Range | Corresponding | |
|---|---|---|
| designation | frequency range | Subcarrier Spacing (SCS) |
| FR1 | 410 MHz-7125 MHz | 15, 30, 60 kHz |
| FR2 | 24250 MHz-52600 MHz | 60, 120, 240 kHz |

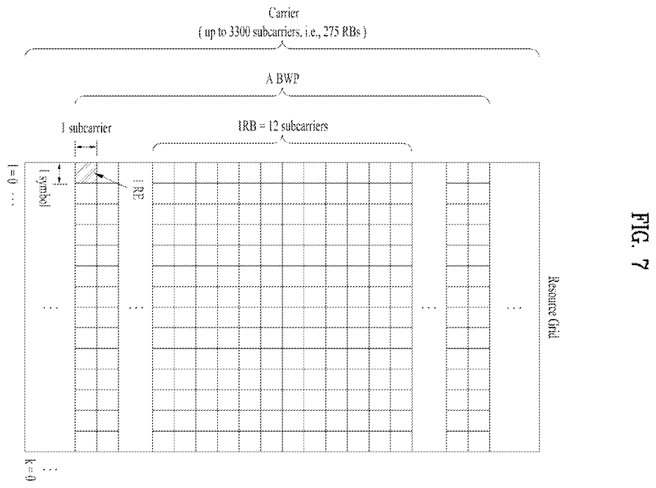

FIG. 7 illustrates a slot structure in an NR frame according to an embodiment of the present disclosure.

Referring to FIG. 7, a slot includes a plurality of symbols in the time domain. For example, one slot may include 14 symbols in an NCP case and 12 symbols in an ECP case. Alternatively, one slot may include 7 symbols in an NCP case and 6 symbols in an ECP case.

A carrier includes a plurality of subcarriers in the frequency domain. An RB may be defined by a plurality of (e.g., 12) consecutive subcarriers in the frequency domain. A bandwidth part (BWP) may be defined by a plurality of consecutive (physical) RBs ((P)RBs) in the frequency domain and correspond to one numerology (e.g., SCS, CP length, or the like). A carrier may include up to N (e.g., 5) BWPs. Data communication may be conducted in an activated BWP. Each element may be referred to as a resource element (RE) in a resource grid, to which one complex symbol may be mapped.

A radio interface between UEs or a radio interface between a UE and a network may include L1, L2, and L3. In various embodiments of the present disclosure, L1 may refer to the PHY layer. For example, L2 may refer to at least one of the MAC layer, the RLC layer, the PDCH layer, or the SDAP layer. For example, L3 may refer to the RRC layer.

Now, a description will be given of sidelink (SL) communication.

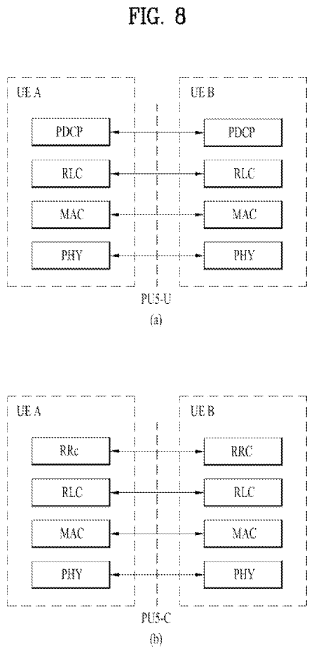

FIG. 8 illustrates a radio protocol architecture for SL communication according to an embodiment of the present disclosure. Specifically, FIG. 8(a) illustrates a user-plane protocol stack in LTE, and FIG. 8(b) illustrates a control-plane protocol stack in LTE.

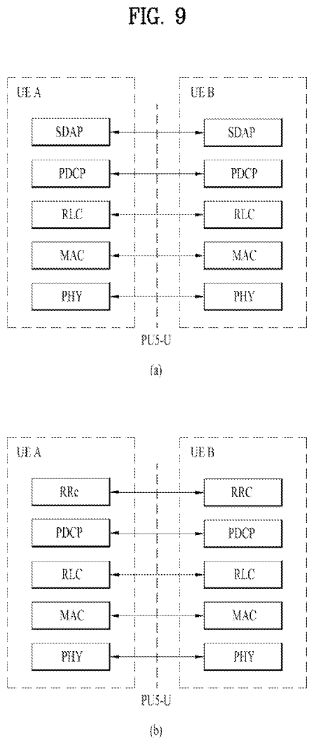

FIG. 9 illustrates a radio protocol architecture for SL communication according to an embodiment of the present disclosure. Specifically, FIG. 9(a) illustrates a user-plane protocol stack in NR, and FIG. 9(b) illustrates a control-plane protocol stack in NR.

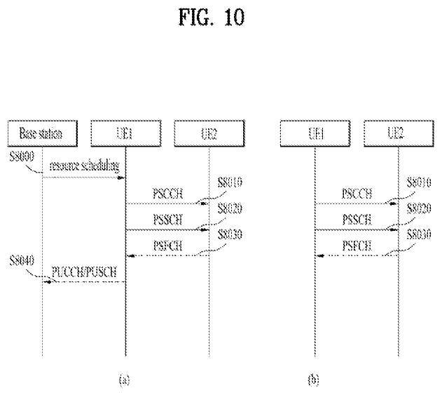

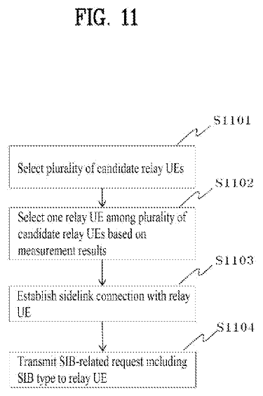

FIG. 10 illustrates a procedure of performing V2X or SL communication by a UE depending on a transmission mode according to an embodiment of the present disclosure. The embodiment of FIG. 10 may be combined with various embodiments of the present disclosure. In various embodiments of the present disclosure, a transmission mode may be referred to as a mode or a resource allocation mode. For the convenience of the following description, a transmission mode in LTE may be referred to as an LTE transmission mode, and a transmission mode in NR may be referred to as an NR resource allocation mode.

For example, FIG. 10(a) illustrates a UE operation related to LTE transmission mode 1 or LTE transmission mode 3. Alternatively, for example, FIG. 10(a) illustrates a UE operation related to NR resource allocation mode 1. For example, LTE transmission mode 1 may apply to general SL communication, and LTE transmission mode 3 may apply to V2X communication.

For example, FIG. 10(b) illustrates a UE operation related to LTE transmission mode 2 or LTE transmission mode 4. Alternatively, for example, FIG. 10(b) illustrates a UE operation related to NR resource allocation mode 2.

Referring to FIG. 10(a), in LTE transmission mode 1, LTE transmission mode 3, or NR resource allocation mode 1, a BS may schedule an SL resource to be used for SL transmission by a UE. For example, in a step S8000, the BS may transmit information related to an SL resource and/or information related to a UE resource to a first UE. For example, the UL resource may include a PUCCH resource and/pr a PUSCH resource. For example, the UL resource may be a resource to report SL HARQ feedback to the BS.

For example, a first UE may receive information related to a Dynamic Grant (DG) resource and/or information related to a Configured Grant (CG) resource from a BS. For example, the CG resource may include a CG type 1 resource or a CG type 2 resource. In the present specification, the DG resource may be a resource that the BS configures/allocates to the first UE over Downlink Control Information (DCI). In the present specification, the CG resource may be a (periodic) resource configured/allocated by the BS to the first UE over a DCI and/or an RRC message. For example, in the case of the CG type 1 resource, the BS may transmit an RRC message including information related to the CG resource to the first UE. For example, in the case of the CG type 2 resource, the BS may transmit an RRC message including information related to the CG resource to the first UE, and the BS may transmit DCI related to activation or release of the CG resource to the first UE.

In a step S8010, the first UE may transmit PSCCH (e.g., Sidelink Control Information (SCI) or 1st-stage SCI) to a second UE based on the resource scheduling. In a step S8020, the first UE may transmit PSSCH (e.g., 2nd-stage SCI, MAC PDU, data, etc.) related to the PSCCH to the second UE. In a step S8030, the first UE may receive PSFCH related to the PSCCH/PSSCH from the second UE. For example, HARQ feedback information (e.g., NACK information or ACK information) may be received from the second UE over the PSFCH. In a step S8040, the first UE may transmit/report HARQ feedback information to the BS over PUCCH or PUSCH. For example, the HARQ feedback information reported to the BS may include information generated by the first UE based on HARQ feedback information received from the second UE. For example, the HARQ feedback information reported to the BS may include information generated by the first UE based on a preset rule. For example, the DCI may be a DCI for scheduling of SL. For example, the format of the DCI may include DCI format 3_0 or DCI format 3_1. Table 5 shows one example of DCI for scheduling of SL.

TABLE 5
7.3.1.4.1 Format 3_0
DCI format 3_0 is used for scheduling of NR PSCCH and NR PSSCH in one cell.
The following information is transmitted by means of the DCI format 3_0 with CRC scrambled by SL-RNTI or SL-CS-
RNTI:

| - | Resource pool index -[log₂ I] bits, where I is the number of resource pools for transmission configured by the | |
|---|---|---|
| | higher layer parameter sl-TxPoolScheduling. | |
| - | Time gap - 3 bits determined by higher layer parameter sl-DCI-ToSL-Trans, as defined in clause 8.1.2.1 of [6, | |
| | TS 38.214] | |
| - | HARQ process number - 4 bits. | |
| - | New data indicator - 1 bit. | |
| - | Lowest index of the subchannel allocation to the initial transmission - ┌log₂(N_{subChannel}^{SL})┐ bits as defined in clause | |
| | 8.1.2.2 of [6, TS 38.214] | |
| - | SCI format 1-A fields according to clause 8.3.1.1: | |
| | - | Frequency resource assignment. |
| | - | Time resource assignment. |
| - | PSFCH-to-HARQ feedback timing indicator -┌log₂ Nₜₕ_timing┐ bits, where Nₜₕ_timing is the number of entries in | |
| | the higher layer parameter sl-PSFCH-ToPUCCH, as defined in clause 16.5 of [5, TS 38.213] | |
| - | PUCCH resource indicator - 3 bits as defined in clause 16.5 of [5, TS 38.213]. | |
| - | Configuration index - 0 bit if the UE is not configured to monitor DCI format 3_0 with CRC scrambled by SL- | |
| | CS-RNTI; otherwise 3 bits as defined in clause 8.1.2 of [6, TS 38.214]. If the UE is configured to monitor DCI | |
| | format 3_0 with CRC scrambled by SL-CS-RNTI, this field is reserved for DCI format 3_0 with CRC scrambled | |
| | by SL-RNTI. | |
| - | Counter sidelink assignment index - 2 bits | |
| | - | 2 bits as defined in clause 16.5.2 of [5, TS 38.213] if the UE is configured with pdsch-HARQ-ACK-Codebook = |
| | | dynamic |
| | - | 2 bits as defined in clause 16.5.1 of [S, TS 38.213] if the UB is configured with pdsch-HARQ-ACK-Codebook = |
| | | semi-static |

| | |
|---|---|
| - | Padding bits, if required |

If multiple transmit resource pools are provided in sl-TxPoolScheduling, zeros shall be appended to the DCI format 3_0
until the payload size is equal to the size of a DCI format 3_0 given by a configuration of the transmit resource pool
resulting in the largest number of information bits for DCI format 3_0.
If the UE is configured to monitor DCI format 3_1 and the number of information bits in DCI format 3_0 is less than
the payload of DCI format 3_1, zeros shall be appended to DCI format 3_0 until the payload size equals that of DCI
format 3_1.
7.3.1.4.2 Format 3_1
DCI format 3_1 is used for scheduling of LTE PSCCH and LTE PSSCH in one cell.
The following information is transmitted by means of the DCI format 3_1 with CRC scrambled by SL Semi-Persistent
Scheduling V-RNTI:

| | |
|---|---|
| - | Timing offset - 3 bits determined by higher layer parameter si-TimeOffsetEUTRA, as defined in clause 16.6 of |
| | [5, TS 38.213] |
| - | Carrier indicator - 3 bits as defined in 5.3.3.1.9A of [11, TS 36.212]. |
| - | Lowest index of the subchannel allocation to the initial transmission - ┌log₂(N_{subChannel}^{SL})┐ bits as defined in |
| | 5.3.3.1.9A of [11, TS 36.212]. |
| - | Frequency resource location of initial transmission and retransmission, as defined in 5.3.3.1.9A of [1], TS |
| | 36.212] |
| - | Time gap between initial transmission and retransmission, as defined in 5.3.3.1.9A of [11, TS 36.212] |
| - | SL index-2 bits as defined in 5.3.3.1.9A of [11, TS 36.212] |
| - | SL SPS configuration index - 3 bits as defined in clause 5.3.3.1.9A of [11, TS 36.212]. |
| - | Activation/release indication - 1 bit as defined in clause 5.3.3.1.9A of [11, TS 36.212]. |

Referring to FIG. 10(b), for LTE transmission mode 2, LTE transmission mode 4, or NR resource allocation mode 2, a UE may determine an SL transmission resource from among SL resources configured by a BS/network or preconfigured SL resources. For example, the configured SL resources or preconfigured SL resources may be a resource pool. For example, the UE may autonomously select or schedule resources for SL transmission. For example, the UE may perform SL communication by selecting a resource by itself within a configured resource pool. For example, the UE may perform sensing and resource (re) selection procedures to select a resource by itself within a selection window. For example, the sensing may be performed in unit of a sub-channel. For example, in step S8010, the first UE having self-selected a resource in the resource pool may transmit a PSCCH (e.g., Sidelink Control Information (SCI) or 1^{st}-stage SCI) to the second UE using the resource. In step S8020, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIG. 10(a) or FIG. 10(b), for example, the first UE may transmit the SCI to the second UE on the PSCCH. Alternatively, for example, the first UE may transmit two consecutive SCIs (e.g., two-stage SCI) to the second UE on the PSCCH and/or PSSCH. In this case, the second UE may decode the two consecutive SCIs (e.g., two-stage SCI) to receive the PSSCH from the first UE. In the present specification, the SCI transmitted on the PSCCH may be referred to as 1st SCI, 1st-stage SCI, or a 1st-stage SCI format, and the SCI transmitted on the PSSCH may be referred to as 2nd SCI, 2nd SCI, or a 2nd-stage SCI format. For example, the 1st-stage SCI format may include SCI format 1-A, and the 2nd-stage SCI format may include SCI format 2-A and/or SCI format 2-B. Table 6 shows one example of a 1st-stage SCI format.

```
TABLE 6
8.3.1.1 SCI format 1-A
SCI format 1-A is used for the scheduling of PSSCH and 2^{nd}-stage-SCI on PSSCH
The following information is transmitted by means of the SCI format 1-A:
  - Priority - 3 bits as specified in clause 5.4.3.3 of [12, TS 23.287] and clause 5.22.1.3.1 of [8, TS 38.321]. Value
      ′000′ of Priority field corresponds to priority value ′1′, value ′001′ of Priority field corresponds to priority value
      ′2′, and so on.
  -  $Frequency resource assignment - ⌈ {log}_{2} ( \frac{{N}_{subChannel}^{SL} ( {N}_{subChannel}^{SL} + 1 )}{2} ) ⌉ bits when the value of the higher layer$
  -  $parameter sl - MaxNumPerReserve is configured to 2 ; otherwise ⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$
      bits when the value of the higher layer parameter sl-MaxNumPerReserve is configured to 3, as defined in clause
      8.1.5 of [6, TS 38.214].
  - Time resource assignment - 5 bits when the value of the higher layer parameter sl-MaxNumPerReserve is
      configured to 2; otherwise 9 bits when the value of the higher layer parameter sl-MaxNumPerReserve is
      configured to 3, as defined in clause 8.1.5 of [6, TS 38.214].
  - Resource reservation period - ┌log₂ Nᵣₛᵥ_period┐ bits as defined in clause 16.4 of [5, TS 38.213], where
      Nᵣₛᵥ_period is the number of entries in the higher layer parameter sl-ResourceReservePeriodList, if higher layer
      parameter sl-MultiReserveResource is configured; 0 bit otherwise.
  - DMRS pattern - ┌log₂ Nₚₐₜₜₑᵣₙ┐ bits as defined in clause 8.4.1.1.2 of [4, TS 38.211], where Nₚₐₜₜₑᵣₙ is the
      number of DMRS patterns configured by higher layer parameter sl-PSSCH-DMRS-TimePatternList.
  - 2^{nd}-stage SCI format - 2 bits as defined in Table 8.3.1.1-1.
  - Beta_offset indicator - 2 bits as provided by higher layer parameter sl-BetaOffsets2ndSCI and Table 8.3.1.1-2.
  - Number of DMRS port - 1 bit as defined in Table 8.3.1.1-3.
  - Modulation and coding scheme - 5 bits as defined in clause 8.1.3 of [6, TS 38.214].
  - Additional MCS table indicator - as defined in clause 8.1.3.1 of [6, TS 38.214]: 1 bit if one MCS table is
      configured by higher layer parameter sl-Additional-MCS-Table; 2 bits if two MCS tables are configured by
      higher layer parameter sl- Additional-MCS-Table; 0 bit otherwise.
  - PSFCH overhead indication - 1 bit as defined clause 8.1.3.2 of [6, TS 38.214] if higher layer parameter sl-
      PSFCH-Period = 2 or 4; 0 bit otherwise.
  - Reserved - a number of bits as determined by higher layer parameter sl-NumReservedBits, with value set to zero.
```

Table 7 shows one example of a 2nd-stage SCI format.

TABLE 7

| | |
|---|---|
| 8.4 | Sidelink control information on PSSCH Sidelink control information on PSSCH |

SCI carried on PSSCH is a 2^{nd}-stage SCI, which transports sidelink scheduling information.

| | |
|---|---|
| 8.4.1 | 2^{nd}-stage SCI formats 2110-stage SCI formats |

The fields defined in each of the 2^{nd}-stage SCI formats below are mapped to the information bits α₀ to α_{A-1} as
follows:
Each field is mapped in the order in which it appears in the description, with the first fiekl mapped to the lowest order
information bit α₀ and each successive field mapped to higher order information bits. The most significant bit of each
field is mapped to the lowest order information bit for that field, e.g. the most significant bit of the first field is mapped
to α₀.

| | |
|---|---|
| 8.4.1.1 | SCI format 2-A SCI format 2-A |

```
SCI format 2-A is used for the decoding of PSSCH, with HARQ operation when HARQ-ACK information includes
ACK or NACK, when HARQ-ACK information includes only NACK, or when there is no feedback of HARQ-ACK
information.
The following information is transmitted by means of the SCI format 2-A:
  - HARQ process number - 4 bits. process number-4 bits.
  - New data indicator - 1 bit. data indicator-1 bit.
  - Redundancy version - 2 bits as defined in Table 7.3.1.1.1-2.
  - Source ID - 8 bits as defined in clause 8.1 of [6, TS 38.214].
  - Destination ID - 16 bits as defined in clause 8.1 of [6, TS 38.214].
  - HARQ feedback enabled/disabled indicator - 1 bit as defined in clause 16.3 of [5, TS 38.213].
  - Cast type indicator - 2 bits as defined in Table 8.4.1.1-1 and in clause 8.1 of [6, TS 38.214].
  - CSI request - 1 bit as defined in clause 8.2.1 of [6, TS 38.214] and in clause 8.1 of [6, TS 38.214].
```

Referring to FIG. 10(a) or FIG. 10(b), in step S8030, the first UE may receive the PSFCH based on Table 8. For example, the first UE and the second UE may determine a PSFCH resource based on Table 8, and the second UE may transmit HARQ feedback to the first UE using the PSFCH resource.

TABLE 8
16.3 UE procedure for reporting HARQ-ACK on sidelink

A UE can be indicated by an SCI format scheduling a PSSCH reception to transmit a PSFCH with HARQ-ACK
information in response to the PSSCH reception. The UE provides HARQ-ACK information that includes ACK or
NACK, or only NACK
A UE can be provided, by sl-PNFCH-Period, a number of slots in a resource pool for a period of PSFCH transmission
occasion resources. If the number is zero. PSFCH transmissions from the UE in the resource pool are disabled.
A UE expects that a slot t′ₖ^{SL} (0 ≤ k < T′ m [symbol] ) has a PSFCH transmission occasion resource if k mod N_{PSSCH}^{PSPCH} = 0,
where t′ₖ^{SL} is defined in [6, TS 38.214], and T′ m [symbol] is a number of slots that belong to the resource pool within 10240
msec according to [6.TS 38.214], and N_{PSSCH}^{PSFCH} is provided by si-PSFCH-Period.
A UE may be indicated by Ingher layers to not transmit a PSPCH in response to a PSSCH reception [11, TS 38.321].
If a UE receives a PSSCH in a resource pool and the HARQ feedback enabled/disabled indicator field in an associated
SCI format 2-A or a SCI format 2-B has value 1 [5, TS 38.212], the UE provides the HARQ-ACK information in a
PSFCH transmission in the resource pool. The UE transmits the PSFCH in a first slot that includes PSFCH resources
and is at least a number of slots, provided by sl-MinTimeGapPSFCH of the resource pool after a last slot of the PSSCH
reception.
A UE is provided by sl-PSFCH-RB-Set a set of M [symbol] PRBs in a resource pool for PSPCH transmission in a PEB of
the resource pool. For a number of N [symbol] sub-channels for the resource pool, provided by sl-NumSubchannel, and a
number of PSSCH slots associated with a PSFCH slot that is less than or equal to N [symbol] , the UE allocates the
[(t + j · N [symbol] ) · M [symbol] , (t + 1 + j · N [symbol] ) · M [symbol] − 1] PRBs from the M [symbol] PRBs to slot i among the
PSSCH slots associated with the PSFCH slot and sub-channel j, where M_{subch,slot}^{PSFCH} = M [symbol] /(N_{subch} · N [symbol] ),
0 ≤ i < N_{PSSCH}^{PSFCH}, 0 ≤ j < N_{subch}, and the allocation starts in an ascending order of i and continues in an ascending
order of j. The UE expects that M_{PRP,set}^{PSPCH} is a multiple of N_{subch} · N_{PSSCH}^{PSFCH}.
The second OFDM symbol t′ of PSFCH transmission in a slot is defined as
t′ = [symbol] + [symbol] − 2 .
A UE determines a number of PSFCH resources available for multiplexing HARQ-ACK information in a PSFCH
transmission as R_{PRB,CS}^{PSSCH} = N_{type}^{PSFCH} · M_{subch,slot}^{PSFCH} where N_{CS}^{PSSCH} is a number of cyclic shift pairs for the resource
pool provided by sl-NumMaxCS-Pair and, based on an indication by sl-PSFCH-CandidateResourceType,

| | |
|---|---|
| - | if sl-PSFCH-CandidateResourceType is configured as startSubCH, N_{type}^{PSFCH} = 1 and the M_{subch,slot}^{PSFCH} PRBs are |
| | associated with the starting sub-channel of the corresponding PSSCH; |
| - | if sl-PSFCH-CandidateResourceType is configured as allocSubCH, N_{type}^{PSFCH} = N_{subch}^{PSFCH} and the N_{subch}^{PSFCH}, |
| | M_{subch,slot}^{PSFCH} PRBs are associated with the N_{subch}^{PSFCH} sub-channels of the corresponding PSSCH. |

The PSFCH resources are first indexed according to an ascending order of the PRB index, from the N_{type}^{PSFCH} · M_{subch,slot}^{PSFCH}
PRBs, and then according to an ascending order of the cyclic shift pair index from the N_{CS}^{PSSCH} cyclic shift pairs.
A UE determines an index of a PSFCH resource for a PSFCH transmission in response to a PSSCH reception as
(P_{ID} + M_{ID})m odR_{PRB,CS}^{PSFCH} where P_{ID} is a physical layer source ID provided by SCI format 2-A or 2-B [5, TS 38.212]
scheduling the PSSCH reception, and M_{ID} is the identity of the UE receiving the PSSCH as indicated by higher layers
if the UE detects a SCI format 2-A with Cast type indicator field value of “01”; otherwise, M_{ID} is zero.
A UE determines a m₀ value, for computing a value of cyclic shift α [4, TS 38.211], from a cyclic shift pair index
corresponding to a PSFCH resource index and from N_{CS}^{PSFCH} using Table 16.3-1. [symbol]
indicates data missing or illegible when filed

Referring to FIG. 10(a), in step S8040, the first UE may transmit SL HARQ feedback to the BS over the PUCCH and/or PUSCH based on Table 9.

TABLE 9
16.5 UE procedure for reporting HARQ-ACK on uplink

A UE can be provided PUCCH resources or PUSCH resources [12, TS 38.331] to repost HARQ-ACK mformation that
the UE generates based on HARQ-ACK information that the UE obtains fom PSFCH receptions, or from absence of
PSFCH receptions. The UE report: HARQ-ACK information on the primary cell of the PUCCH group, as described as
clause 9, of the cell where the UE monitors PDCCH for detection of DCI format 3_0.
For SL configured grant Type 1 or Type 2 PSSCH transmissions by a UE within a time period provided by sl-PeriodCG
the UE generates one HARQ-ACK information bit in response to the PSFCH receptions to multiplex in a PUCCH
transmission occasion that is after a last time resource, in a set of time resources.
For PSSCH transmissions scheduled by a DCI format 3_0, a UE generates HARQ-ACK information in response to
PSFCH receptions to multiplex in a PUCCH transmission occasion that is after a last time resource in a set of time
resources provided by the DCI format 3_0.
From a number of PSFCH reception occasions, the UE generates HARQ-ACK information to report in a PUCCH or
PUSCH transmission. The UE can be indicated by a SCI format to perform one of the following and the UE constructs
a HARQ-ACK codeword with HARQ-ACK information, when applicable.

| - | for one or more PSFCH reception occasions associated with SCI format 2-A with Cast type indicator field value | |
|---|---|---|
| | of “10” | |
| | - | generate HARQ-ACK information with same value as a value of HARQ-ACK information the UE |
| | | determines from the last PSFCH reception from the number of PSFCH reception occasions corresponding to |
| | | PSSCH transmissions or, if the UE determines that a PSFCH is not received at the last PSFCH reception. |
| | | occasion and ACK is not received in any of previous PSFCH reception occasions, generate NACK |
| - | for one or more PSFCH reception occasion associated with SCI format 2-A with Cast type indicator field value | |
| | of “01” | |
| | - | generate ACK if the UE determines ACK from at least one PSFCH reception occasion, from the number of |
| | | PSFCH reception occasions corresponding to PSSCH transmissions, in PSFCH resources cooresponding to |
| | | every identity M_{ID} of the UEs that the UE expects to receive the PSSCH, as described in clause 16.3; |
| | | otherwise, generate NACK |
| - | for one or more PSFCH reception occasions associated with SCI format 2-B or SCI format 2-A with Cast type | |
| | indicator field value of “11” | |
| | - | generate ACK when the UE determines absence of PSFCH reception for the last PSFCH reception occasion. |
| | | from the number of PSFCH reception occasions corresponding to PSSCH transmissions; otherwise, generate |
| | | NACK |

After a UE transmits PSSCHs and receives PSFCHs in corresponding PSFCH resource occasions, the priority value of
HARQ-ACK information is same as the priority value of the PSSCH transmissions that is associated with the PSFCH
reception occasions providing the HARQ-ACK information.
The UE generates a NACK when, due to prioritization, as described in clause 16.2.4, the UE does not receive PSPCH in
any PSFCH reception occasion associated with a PSSCH transmission in a resource provided by a DCI format 3_0 or,
for a configured grant, in a resource provided in a single period and for which the UE is provided a PUCCH resources to
report HARQ-ACK information. The priority value of the NACK is same as the priority value of the PSSCH
transmission.
The UE generates a NACK when, due to prioritization as described in clause 162.4, the UE does not transmit a PSSCH
in any of the resources provided by a DCI format 3_0 or, for a configured grant, in any of the resources provided is a
single period and for which the UE is provided a PUCCH resource to report HARQ-ACK information. The priority
value of the NACK is same as the priority value of the PSSCH that was not transmitted due to prioritization.
The UE generates an ACK if the UE does not transmit PSCCH with a SCI format 1-A scheduling a PSSCH in any of
the resources provided by a configured grant in a single period and for which the UE is provided a PUCCH resource to
report HARQ-ACK information. The priority value of the ACK is same as the largest priority value among the possible
priority values for the configured grant.

### Sidelink (SL) Discontinuous Reception (DRX)

A MAC entity is a DRX function of controlling a UE's PDCCH monitoring activity for C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI, and SL Semi-Persistent Scheduling V-RNTI of the MAC entity, and may be configured by RRC. When using a DRX operation, the MAC entity should monitor PDCCH according to prescribed requirements. When DRX is configured in RRC_CONNECTED, the MAC entity may discontinuously monitor PDCCH for all activated serving cells.

RRC may control DRX operation by configuring the following parameters.
drx-onDurationTimer: Duration time when DRX cycle starts
drx-SlotOffset: Delay before drx-onDurationTimer starts
drx-Inactivity Timer: Duration time thereafter when PDCCH indicates a new UL or DL transmission for a MAC entity
drx-Retransmission TimerDL (per DL HARQ process except for the broadcast process): Maximum duration time until DL retransmission is received
drx-Retransmission TimerUL (per UL HARQ process): Maximum duration until approval for UL retransmission is received
drx-LongCycleStartOffset: Long DRX cycle and drx-StartOffset that define a subframe in which Long and Short DRX cycles start
drx-ShortCycle (optional): Short DRX cycle
drx-ShortCycleTimer (optional): Duration for which a UE should follow a short DRX cycle
drx-HARQ-RTT-TimerDL (per DL HARQ process except for the broadcast process): Minimum duration time before DL allocation for HARQ retransmission is estimated by a MAC entity
drx-HARQ-RTT-TimerUL (per UL HARQ process): Minimum duration time before a UL HARQ retransmission approval is estimated by a MAC entity
drx-RetransmissionTimerSL (per HARQ process): Maximum duration until an approval for SL retransmission is received
drx-HARQ-RTT-TimerSL (per HARQ process): Minimum duration time before an SL retransmission approval is estimated by a MAC entity
ps-Wakeup (optional): Configuration for starting drx-onDurationTimer connected when DCP is monitored but not detected
ps-TransmitOtherPeriodicCSI (optional): Configuration for reporting a periodic CSI that is not L1-RSRP on PUCCH for time duration indicated by drx-onDurationTimer when connected drx-onDurationTimer does not start despite that DCP is configured
ps-TransmitPeriodicL1-RSRP (optional): Configuration for transmitting a periodic CSI that is L1-RSRP on PUCCH for a time indicated by drx-onDurationTimer when connected drx-onDurationTimer does not start despite that DCP is configured

A serving cell of a MAC entity may be configured in two DRX groups having separate DRX parameters by RRC. When the RRC does not configure a secondary DRX group, a single DRX group exists only and all serving cells belong to the single group. When two DRX groups are configured, each serving cell is uniquely allocated to each of the two groups. DRX parameters separately configured for each DRX group include drx-onDurationTimer and drx-Inactivity Timer. DRX parameters common to the DRX groups are as follows.

drx-onDurationTimer, drx-Inactivity Timer.

DRX parameters common to DRX groups are as follows.

drx-SlotOffset, drx-RetransmissionTimerDL, drx-Retrans drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

In the legacy Uu DRX operation, drx-HARQ-RTT-TimerDL, drx-HARQ-RTT-TimerUL, drx-RetransmissionTimerDL, and drx-RetransmissionTimerUL are defined. When the UE performs HARQ retransmission, the UE may be allowed to transition to the sleep mode during a round trip time (RTT) timer (drx-HARQ-RTT-TimerDL, drx-HARQ-RTT-TimerUL, etc.) or maintain the active state during a retransmission timer (drx-Retransmission TimerDL, drx-RetransmissionTimerUL, etc.)

Details of SL DRX in R2-2111419 of TS 38.321 may be referred to as the prior art.

Table 10 below shows disclosed information related to selection and reselection of a sidelink relay UE in 3GPP TS 36.331. The disclosed information in Table 10 is used as the related art of the disclosure, related necessary details refer to 3GPP TS 36.331.

TABLE 10
The MAC entity may be configured by RRC with a DRX functionality that controls the UE's PDCCH monitoring
activity for the MAC entity's C-RNTI, CI-RNTI, CS-RNTI, INT-RNTI, SFI-RNTI, SP-CSI-RNTI, TPC-PUCCH-
RNTI, TPC-PUSCH-RNTI TPC-SRS-RNTI, and AI-RNTI. When using DRX operation, the MAC entity shall also
monitor PDCCH according to requirements found in other clauses of this specification. When in RRC_CONNECTED,
if DRX is configured, for all the activated Serving Cells, the MAC entity may ssonitos the PDCCH discontinuously
using the DRX operation specified in this clause; otherwise the MAC entity shall monitor the PDCCH as specified in
TS 38.213 [6].

NOTE 1: If Sideline resource allocation mode 1 is configured by RRC, & DRX functionality is not configured.

RRC controls DRX operation by configuring the following parameters:

| | |
|---|---|
| - | drx-onDurationTimer; the duration at the beginning of a DRX cycle; |
| - | drx-SlotOffset; the delay before starting the drx-onDurationTimer; |
| - | drx-InactivityTimer; the duration after the PDCCH occasion in which a PDCCH indicates a new UL or DL |
| | transmission for the MAC entity; |
| - | drx-RetransmissionTimerDL (per DL HARQ process except for the broadcast process); the maximum duration |
| | until a DL retransmission is received; |
| - | drx-RetransmissionTimerUL (per UL HARQ process); the maximum duration until a grant for UL |
| | retransmission is received; |
| - | drx-LongCycleStartOffset: the Long DRX cycle and drx-StartOffset which defines the subframe where the Long |
| | and Short DRX cycle starts; |
| - | drx-ShortCycle (optional): the Short DRX cycle; |
| - | drx-ShortCycleTimer (optional): the duration the UE shall follow the Short DRX cycle; |
| - | drx-HARQ-RTT-TimerDL (per DL HARQ process except for the broadcast process); the minimum duration |
| | before a DL assignment for HARQ retransmission is expected by the MAC entity; |
| - | drx-HARQ-RTT-TimerUL (per UL HARQ process); the minimum duration before a UL HARQ retransmission |
| | grant is expected by the MAC entity; |
| - | ps-Wakeup (optional): the configuration to start associated drx-onDurationTimer in case DCP is monitored but |
| | not detected; |
| - | ps-TransmitOtherPeriodicCSI (optional): the configuration to report periodic CSI that is not L1-RSRP on |
| | PUCCH during the time duration indicated by drx-onDurationTimer in case DCP is configured but associated |
| | drx-onDurationTimer is not started; |
| - | ps-TransmitPeriodicL1-RSRP (optional): the configuration to transmit periodic CSI that is L1-RSRP on |
| | PUCCH during the time duration indicated by drx-onDurationTimer in case DCP is configured but associated |
| | drx-onDurationTimer is not started; |

Serving Cells of a MAC entity may be configured by RRC in two DRX groups with separate DRX parameters. When
RRC does not configure a secondary DRX group, there is only one DRX group and all Serving Cells belong to that one
DRX group. When two DRX groups are configured, each Serving Cell is uniquely assigned to either of the two groups.
The DRX parameters that are separately configured for each DRK group are: drx-onDurationTimer, drx-
Inactivity Timer. The DRX parameters that are common to the DRK groups are: drx-SlotOffset, drx-
RetransmissionTimerDL, drx-RetransmissionTimerUL, drx-LongCycleStartOffset, drx-ShortCycle (optional), drx-
ShortCycleTimer (optional), drx-HARQ-RTT-TimerDL, and drx-HARQ-RTT-TimerUL.
When a DRX cycle is configured, the Active Time for Serving Cells in a DRX group includes the time while:

| | |
|---|---|
| - | drx-onDurationTimer or drx-InactivityTimer configured for the DRX group is running; or |
| - | drx-RetransmissionTimerDL or drx-RetransmissionTimerUL is running on any Serving Cell in the DRX group; |

TABLE 11

| | |
|---|---|
| | or |
| - | ra-ContentionResolutionTimer (as described in clause 5.1.5) or msgB-ResponseWindow (as described in clause |
| | 5.1.4a) is running; or |
| - | a Sheduling Request is sent on PUCCH and is pending (as described in clause 5.4.4); or |
| - | a PDCCH indicating a new transmission addressed to the C-RNTI of the MAC entity has not been received |
| | after successful reception of a Random Access Response for the Random Access Preamble not selected by the |
| | MAC entity among the contention-based Random Access Preamble Access Preamble (as described in clauses 5.1.4 and 5.1.4a). |

When DRX is configured, the MAC entity shall:

| 1> | if a MAC PDU is received in a configured downlink assignment. | | |
|---|---|---|---|
| | 2> | start the drx-HARQ-RTT-TimerDL for the corresponding HARQ process in the first symbol after the end of | |
| | | the corresponding transmission carrying the DL HARQ feedback; | |
| | 2> | stop the drx-RetransmissionTimerDL for the corresponding HARQ process. | |
| 1> | if a MAC PDU is transmitted in a configured uplink grant and LBT failure indication is not received from lower | | |
| | layers; | | |
| | 2> | start the drx-HARQ-RTT-TimerUL for the corresponding HARQ process in the first symbol after the end of | |
| | | the first repetition of the corresponding PUSCH transmission; | |
| | 2> | stop the drx-RetransmissionTimerUL for the corresponding HARQ process. | |
| 1> | if a drx-HARQ-RTT-TimerDL expires: | | |
| | 2> | if the data of the corresponding HARQ process was not successfully decoded: | |
| | | 3> | start the drx-RetransmissionTimerDL for the corresponding HARQ process in the first symbol after the |
| | | | expiry of drx-HARQ-RTT-TimerDL. |
| 1> | if a drx-HARQ-RTT-TimerUL expires: | | |
| | 2> | start the drx-RetransmissionTimerUL for the corresponding HARQ process in the first symbol after the | |
| | | expiry of drx-HARQ-RTT-TimerUL. | |
| 1> | if a DRX Command MAC CE or a Long DRX Command MAC CE is received: | | |
| | 2> | stop drx-onDurationTimer for each DRX group; | |
| | 2> | stop drx-InactivityTimer for each DRX group. | |
| 1> | if drx-InactivityTimer for a DRX group expires: | | |
| | 2> | if the Short DRX cycle is configured: | |
| | | 3> | start or restart drx-ShortCycleTimer for this DRX group in the first symbol after the expiry of drx- |
| | | | InactivityTimer; |
| | | 3> | use the Short DRX cycle for this DRX group. |
| | 2> | else: | |
| | | 3> | use the Long DRX cycle for this DRX group. |
| 1> | if a DRX Command MAC CE is received: | | |
| | 2> | if the Short DRX cycle is configured: | |
| | | 3> | start or restart drx-ShortCycleTimer for each DRX group in the first symbol after the end of DRX |
| | | | Command MAC CE reception; |

TABLE 12

| | | 3> | use the Short DRX cycle for each DRX group. | |
|---|---|---|---|---|
| | 2> | else: | | |
| | | 3> | use the Long DRX cycle for each DRX group. | |
| 1> | if drx-ShortCycleTimer for a DRX group expires: | | | |
| | 2> | use the Long DRX cycle for this DRX group. | | |
| 1> | if a Long DRX Command MAC CE is received: | | | |
| | 2> | stop drx-ShortCycleTimer for each DRX group; | | |
| | 2> | use the Long DRX cycle for each DRX group. | | |
| 1> | if the Short DRX cycle is used for a DRX group, and [(SFN × 10) + subframe number] modulo (drx- | | | |
| | ShortCycle) = (drx-StartOffset) modulo (drx-ShortCycle); | | | |
| | 2> | start drx-onDurationTimer for this DRX group after drx-SlotOffset from the beginning of the subframe. | | |
| 1> | if the Long DRX cycle is used for a DRX group, and [(SFN × 10) + subframe number] modulo (drx-LongCycle) = | | | |
| | drx-StartOffset: | | | |
| | 2> | if DCP monitoring is configured for the active DL BWP as specified in TS 38.213 [6], clause 10.3: | | |
| | | 3> | if DCP indication associated with the current DRX cycle received from lower layer indicated to start | |
| | | | drx-onDurationTimer, as specified in TS 38.213 [6]; or | |
| | | 3> | if all DCP occasion(s) in time domain, as specified in TS 38.213 [6], associated with the current DRX | |
| | | | cycle occured in Active Time considering grants/assignments/DRX Command MAC CE/Long DRX | |
| | | | Command MAC CE received and Scheduling Request sent until 4 ms prior to start of the last DCP | |
| | | | occasion, or within BWP switching interruption length, or during a measurement gap, or when the MAC | |
| | | | entity monitors for a PDCCH transmission on the search space indicated by recoverySearchSpaceId of | |
| | | | the SpCell identified by the C-RNTI while the ra-ResponseWindow is running (as specified in clause | |
| | | | 5.1.4); or | |
| | | 3> | if pr-Wakeup is configured with valve true and BCP indication associated with the current DRX cycle | |
| | | | has not been received from lower layers: | |
| | | | 4> | start drx-onDurationTimer after drx-SlotOffset from the beginning of the subframe. |

| 2> | else: | |
|---|---|---|
| | 3> | start drx-onDurationTimer for this DRX group after drx-SlotOffset from the beginning of the subframe. |

NOTE 2: In case of unaligned SFN scross camera is a cell group, the SFN of the SpCell is used to calculate the

| | | | DRX duration |
|---|---|---|---|
| 1> | if a DRX group is in Active Time: | | |
| | 2> | monitor the PDCCH on the Serving Cells in this DRX group as specified in TS 38.213 [6]; | |
| | 2> | if the PDCCH indicates a DL transmission: | |
| | | 3> | start the drx-HARQ-RTT-TimerDL for the corresponding HARQ process in the first symbol after the end |
| | | | of the corresponding transmission carrying the DL HARQ feedback; |

NOTE 3: When HARQ feedback is postponed by PDSCH-to-HARQ_feedback timing indicating a non-numerical

| | kl value, as specified in TS 38.213 [6], the corresponding transmission opportunity to send the DL | |
|---|---|---|
| | HARQ feedback is indicated in a later PDCCH requesting the HARQ-ACK feedback. | |
| 3> | stop the drx-RetransmissionTimerDL for the corresponding HARQ process. | |
| 3> | if the PDSCH-to-HARQ_feedback timing indicates a non-numerical kl value as specified in TS 38.213 | |
| | [6]: | |
| | 4> | start the drx-RetransmissionTimerDL in the first symbol after the PDSCH transmission for the |
| | | corresponding HARQ process. |

| | |
|---|---|
| 2> | if the PDCCH indicates a UL transmission: |

TABLE 13

| | | 3> | start the drx-HARQ-RTT-TimerUL for the corresponding HARQ process in the first symbol after the end | |
|---|---|---|---|---|
| | | | of the first repetition of the corresponding PUSCH transmission; | |
| | | 3> | stop the drx-RetransmissionTimerUL for the corresponding HARQ process. | |
| | 2> | if the PDCCH indicates a new transmission (DL or UL) on a Serving Cell in this DRX group; | | |
| | | 3> | start or restart drx-InactivityTimer for this DRX group in the first symbol after the end of the PDCCH | |
| | | | reception. | |
| | 2> | if a HARQ process receives downlink feedback information and acknowledgement is indicated: | | |
| | | 3> | stop the drx-RetransmissionTimerUL for the corresponding HARQ process. | |
| 1> | if DCP monitoring is configured for the active DL BWP as specified in TS 38.213 [6], clause 10.3; and | | | |
| 1> | if the current symbol n occurs within drx-onDurationTimer duration; and | | | |
| 1> | if drx-onDurationTimer associated with the current DRX cycle is not stated as specified in this clause: | | | |
| | 2> | the MAC entity would not be in Active Time considering grants/assignments/DRX Command MAC | | |
| | | CE/Long DRX Command MAC CE received and Scheduling Request sent until 4 ms prior to symbol n | | |
| | | when evaluating all DRX Active Time conditions as specified in this clause: | | |
| | | 3> | not transmit periodic SRS and semi-persistent SRS defined in TS 38.214 [7]; | |
| | | 3> | not report semi-persistent CSI configured on PUSCH; | |
| | | 3> | if ps-TransmitPeriodicL1-RSRP is not configured with value true: | |
| | | | 4> | not report periodic CSI that is L1-RSRP on PUCCH. |
| | | 3> | if ps-TransmitOtherPeriodicCSI is not configured with value true: | |
| | | | 4> | not report periodic CSI that is not L1-RSRP on PUCCH. |
| 1> | else: | | | |
| | 2> | in current symbol n, if a DRX group would not be in Active Time considering grants/assignments scheduled | | |
| | | on Serving Cell(s) in this DRX group and DRX Command MAC CE/Long DRX Command MAC CE | | |
| | | received and Scheduling Request sent until 4 ms prior to symbol n when evaluating all DRX Active Time | | |
| | | conditions as specified in this clause: | | |
| | | 3> | not transmit periodic SRS and semi-persistent SRS defined in TS 38.214 [7] in this DRX group; | |
| | | 3> | not report CSI on PUCCH and semi-persistent CSI configured on PUSCH in this DRX group. | |
| | 2> | if CSI masking (csi-Mask) is setup by upper layers: | | |
| | | 3> | in current symbol n, if drx-onDurationTimer of a DRX group would not be running considering | |
| | | | grants/assignments scheduled on Serving Cell(s) in this DRX group and DRX Command MAC CE/Long | |
| | | | DRX Command MAC CE received until 4 ms prior to symbol n when evaluating all DRX Active Time | |
| | | | conditions as specified in this clause; and | |
| | | | 4> | not report CSI on PUCCH in this DRX group. |

| NOTE 4: | If a UE multiplexes a CSI configured on PUCCH with other overlapping UCI(s) according to the |
|---|---|
| | procedure specified in TS 38.213 [6] clause 9.2.5 and this CSI multiplexed with other UCI(s) would be |
| | reported on a PUCCH resource outside DRX Active Time of the DRX group in which this PUCCH is |
| | configured, it is up to UE implementation whether to report this CSI multiplexed with other UCI(s). |

Regardless of whether the MAC entity is monitoring PDCCH or not on the Serving Cells in a DRX group, the MAC
entity transmits HARQ feedback, aperiodic CSI on PUSCH, and aperiodic SRS defined in TS 38.214 [7] on the
Serving Cells in the DRX group when such is expected.
The MAC entity needs not to monitor the PDCCH if it is not a complete PDCCH occasion (e.g. the Active Time starts
or ends in the middle of a PDCCH occasion).

In the past LTE L2 relay (FeD2D [36.746]), when a remote UE was SL-connected to a relay UE for the relay operation, the relay UE delivered an SIB to the remote UE. In the current Rel-17 SL NR relay WI meeting, there is a discussion about whether additional SIB transmission should occur before the remote UE is SL-connected to the relay UE. Table 14 below is an excerpt from TR 36.746.

TABLE 14
5.1.2.3 System information reception for evolved ProSe Remote UE

```
The evolved ProSe UE-to-Network Relay UE supports relaying of system information for the linked evolved
ProSe Remote UEs located in-coverage of E-UTRAN coverage as well as out of E-UTRAN coverage.
The eNB can configure the evolved ProSe UE-to-Network Relay UE whether it can forward the system
information to linked in-coverage evolved ProSe Remote UEs. Alternatively the evolved ProSe UE-to-
Network Relay UE is expected to forward the system information to the in-coverage evolved ProSe Remote UE.
The linked evolved ProSe Remote UE utilizes the system information of the serving cell of the evolved ProSe
UE-to-Network Relay UE.
Not all system information is relayed to the linked evolved ProSe Remote UE via the evolved ProSe UE-to-
Network Relay UE. Essential SIBs are required to be relayed from the evolved ProSe UE-to-Network Relay
UE to all linked evolved ProSe Remote UEs commonly. At least the following SIBs can be considered
asessential SIBs: MIB (SFN, bandwidth). SIB1 (PLMN, cell information), SIB2 (Access Barring
information), FeD2D SIB related info (e.g. SIB18/19 or new SIBs). Evolved ProSe UE-to-Network Relay
UE can optionally forward other SIBs (e.g., SIB10/11/12/13/14/15) depending on the linked evolved ProSe
Remote UEs.
  Editor's Note: It is FFS which other SIBs needs to be forwarded to the evolved ProSe Remote UE and
    what information is provided to the evolved ProSe UE-to-Network Relay UE to indicate which
    SIBs are needed by the evolved ProSe Remote UE.
The evolved ProSe UE-to-Network Relay UE is expected to purely forward the SIBs without changing the
information and format of the SIB. This approach is recommended. Alternatively, the evolved ProSe UE-to-
Network Relay UE can only forward a subset of information of the SIB to the evolved ProSe Remote UE.
  Editor's Note: It is FFS if there is a use case for the evolved ProSe UE-to-Network Relay UE forwarding
    only subset of information of the SIB to the evolved ProSe Remote UB.
An evolved ProSe UE-to-Nerwork Relay UE forwards SIB over sidelink using broadcast/multi-cast.
  Editor's Note: It is FFS if unicast transmission is used for evolved ProSe UE-to-Network Relay UE
    forwarding SIB.
The system information is not delivered periodically to the evolved ProSe Remote UE, but only
when deemed necessary. The evolved ProSe UE-to-Network Relay UE can determine that SIB delivery is
deemed necessary for the evolved ProSe Remote UE when system information is updated.
  Editor's Note: Other reasons for the evolved ProSe UE-to-Network Relay UE determining that SIB
    delivery is deemed necessary are left for WI phase.
```

Table 10 below shows details of selection and reselection of an SL relay UE defined in 3GPP TS 36.331. The contents of Table 15 are used as the prior art of the present disclosure, and related necessary details may be found in 3GPP TS 36.331.

TABLE 15
5.10.11.4 Selection and reselection of sidelink relay UE
A UE capable of sidelink remote UE operation that is configured by upper layers to search for a sidelink relay UE shall:

| 1> | if out of coverage on the frequency used for sidelink communication, as defined in TS 36.304 [4], clause 11.4; or | | |
|---|---|---|---|
| 1> | if the serving frequency is used for sidelink communication and the RSRP measurement of the cell on which the | | |
| | UE camps (RRC_IDLE)/the PCell (RRC_CONNECTED) is below threshHigh within remoteUE-Config: | | |
| | 2> | search for candidate sidelink relay UEs, in accordance with TS 36.133 [16] | |
| | 2> | when evaluating the one or more detected sidelink relay UEs, apply layer 3 filtering as specified in 5.5.3.2 | |
| | | across measurements that concern the same ProSe Relay UE ID and using the filterCoefficient in | |
| | | SystemInformationBlockType 19 (in coverage) or the preconfigured filterCoefficient as defined in 9.3(out of | |
| | | coverage), before using the SD-RSRP measurement results; | |
| NOTE 1: | | | The details of the interaction with upper layers are up to UE implementation. |
| | 2> | if the UE does not have a selected sidelink relay UE: | |
| | | 3> | select a candidate sidelink relay UE which SD-RSRP exceeds q-RxLevMin included in either |
| | | | reselectionInfoIC (in coverage) or reselectionInfoOoC (out of coverage) by minHyst; |
| | 2> | else if SD-RSRP of the currently selected sidelink relay UE is below q-RxLevMin included in either | |
| | | reselectionInfoIC (in coverage) or reselectionInfoOoC (out of coverage); or if upper layers indicate not to use | |
| | | the currently selected sidelink relay: (i.e. sidelink relay UE reselection): | |
| | | 3> | select a candidate sidelink relay UE which SD-RSRP exceeds q-RxLevMin included in either |
| | | | reselectionInfoIC (in coverage) or reselectionInfoOoC (out of coverage) by minHyst, |
| | 2> | else if the UE did not detect any candidate sidelink relay UE which SD-RSRP exceeds q-RxLevMin included | |
| | | in either reselectionInfoIC (in coverage) or reselectionInfoOoC (out of coverage) by minHyst: | |
| | | 3> | consider no sidelink relay UE to be selected; |
| NOTE 2: | | | The UE may perform sidelink relay UE reselection in a manner resulting in selection of the sidelink relay |
| | | | UE, amongst all candidate sidelink relay UEs meeting higher layer criteria, that has the best radio link |
| | | | quality. Further details, including interaction with upper layers, are up to UE implementation. |

5.10.11.5 Sidelink remote UE threshold conditions
A UE capable of sidelink remote UE operation shall:

| 1> | if the threshold conditions specified in this clause were not met: | | |
|---|---|---|---|
| | 2> | if threshHigh is not included in remoteUE-Config within SystemInformationBlockType 19; or | |
| | 2> | if threshHigh is included in remoteUE-Config within SystemInformationBlockType 19; and the RSRP | |
| | | measurement of the PCell, or the cell on which the UE camps, is below threshHigh by hystMax (also included | |
| | | within remote UE-Config): | |
| | | 3> | consider the threshold conditions to be met (entry); |
| 1> | else: | | |
| | 2> | if threshHigh is included in remoteUE-Config within SystemInformationBlockType 19; and the RSRP | |
| | | measurement of the PCell, or the cell on which the UE camps, is above threshHigh (also included within | |
| | | remote UE-Config): | |
| | | 3> | consider the threshold conditions not to be met (leave); |

When a remote UE establishes a PC5-S (or PC5-RRC) connection with a relay UE, the remote UE may receive SIBs. It is currently being discussed in 3GPP RAN2 NR SL relay WI whether the relay UE transmits SIBs before establishing a PC5 connection with the remote UE. Additionally, it is also currently being discussed that when the relay UE attempts to transmit SIBs before establishing a PC5 connection with the remote UE, the relay UE transmits only minimized SIBs.

As described above, the remote UE may receive general SIBs and SIBs related to the relay operation after establishing a PC5-S (or PC5-RRC) connection with the relay UE. The remote UE may also request an on-demand SIB. However, if the relay UE is incapable of supporting the on-demand SIB or related functions/services (or if the capability of the relay UE differs from the capability of the remote UE), there may be limitations on the types of SIBs that the relay UE is capable of forwarding. For example, if the relay UE does not support positioning/multimedia broadcast multicast services (MBMS), the relay UE may not forward related SIBs to the remote UE. Alternatively, if the 3GPP release version of the remote UE is Rel-18, and the 3GPP release version of the relay UE is Rel-17 (that is, if the remote UE has a more recent release version), the relay UE may not forward the SIBs requested by the remote UE.

According to an embodiment, the relay UE may determine a location at which the desired SIB is transmitted by decoding SIB1 and obtaining scheduling information (e.g., based on si-SchedulingInfo). In other words, the relay UE may decode all decodable SIB information. In general, the UE does not interpret SIB information that is beyond its own capability. For example, it is typically understood that if the relay UE has no capability related to positioning/MBMS, the relay UE may not perform decoding of the corresponding SIB information. However, as an exception, even if the relay UE has no capability, the relay UE may perform decoding of all decodable SIB information to forward SIBs to the UE, which is connected to the relay UE, via PC5-S (or PC5-RRC). In this case, even if the relay UE is incapable of interpreting the SIB information, the relay UE may identify the locations where the relevant SIBs exist based on SIB1 and forward the payload to the remote UE. Alternatively, the relay UE may transmit only basic SIBs related to relaying operations and/or SIBs related to its own capability to the remote UE by default. In addition, the relay UE may decode SIBs beyond its own capability based on SIB1 but store the SIBs without further operations. Then, the relay UE may transmit the corresponding SIBs only when the remote UE requests the SIBs on-demand. This is done to reduce unnecessary SIB transmission.

However, when the relay UE does not know the SIB type, the relay UE may not perform decoding because the relay UE is incapable of determining the locations where the corresponding SIBs exist (or where corresponding SIBs are transmitted) based on SIB1. For example, if the relay UE corresponds to Rel-17 and if the remote UE corresponds to Rel-18, the relay UE may not decode SIBs related to Rel-18. Alternatively, for example, if the remote UE transmits the SIB type to the relay UE on-demand, the relay UE may not identify the SIB type.

To address these issues, according to an embodiment, the remote UE may select a plurality of candidate relay UEs (S1101) and then select one of the plurality of candidate relay UEs based on measurement results (S1102). Subsequently, the remote UE may establish an SL connection with the relay UE (S1103). The remote UE may then send a SIB-related request including an SIB type to the relay UE (Step 1104). In this case, based on that the SIB type is beyond the capability of the relay UE, the remote UE may receive a message from the relay UE indicating the relay UE is incapable of supporting the SIB type. In other words, when the relay UE is incapable of supporting the SIB type (for example, when the relay UE has no capability to decode the SIB even if the relay UE receives the SIB from the gNB), the relay UE may also inform the remote UE that the relay UE is incapable of supporting the SIB type.

Upon receiving the message related to the lack of support, the remote UE may perform either relay reselection or reception of the SIB from the gNB, depending on whether the remote UE is located in the coverage of the serving cell. Specifically, based on that the remote UE is located outside the coverage of the serving cell, the remote UE may perform the relay reselection. Considering that the remote UE is located outside the coverage of the serving cell, but it is difficult for the remote UE to receive the SIB through the relay UE, the remote UE may perform the relay reselection to find a relay UE capable of transmitting the SIB type. To this end, when the remote UE receives capability information after establishing a PC5-S connection with the relay UE, the remote UE may request the following information from the relay UE: MBMS/positioning capability, release version, and so on. Upon receiving this information, if the remote UE determines that the relay UE does not support services that the remote UE requires (for example, if the relay UE is incapable of forwarding the relevant SIB), the remote UE may perform the relay reselection.

Alternatively, based on that the remote UE is located in the coverage of the serving cell, the remote UE may directly receive the SIB corresponding to the SIB-related request from the gNB. As an exception, when the remote UE requires an SIB that the relay UE is incapable of forwarding, the remote UE may be allowed to directly request an on-demand SIB from the gNB. In the above scenario, the serving cell of the remote UE may correspond to the serving cell of the relay UE. As long as the remote UE is connected to the relay UE, the serving cell (i.e., cell where the relay UE is camping on) of the relay UE may be considered as the serving cell (i.e., cell where the remote UE is camping on) of the remote UE.

According to the above configuration, even when the capability of the relay UE differs from the capability of the remote UE, and more particularly, when the relay UE is incapable of supporting support an SIB that remote UE requires, the remote UE may still receive the SIB.

The remote UE may obtain the capability of the relay UE from a discovery messages transmitted by the relay UE in conjunction with the above-described embodiment or as an independent configuration. In other words, the relay UE may include information on its capability, for example, MBMS/positioning capability, release version, and so on in the discovery message and transmit the discovery message. Alternatively, when the remote UE needs to receive MBMS/positioning services or when the remote UE has the latest release version, the remote UE may send a solicitation message (discovery message from the remote UE) requesting that such information be included in the discovery message.

The inability to support the SIB type may be based on that the capability of the relay UE differs from the capability of the remote UE. Herein, when it is said that the SIB type is beyond the capability of the relay UE, it may correspond to one of the following cases: when the remote UE is capable of supporting MBMS but the relay UE is incapable of supporting MBMS; when the remote UE is capable of supporting positioning services but the relay UE is incapable of supporting positioning services; and when the standard specification release version (e.g., Rel-18) of the remote UE is higher than the release version (e.g., Rel-17) of the relay UE.

The SIB type may be information indicated by SIB-TypeInfo in SI-SchedulingInfo. Specifically, the SIB type may be one of sibType2, sibType3, sibType4, sibType5, sibType6, sibType7, sibType8, sibType9, sibType10-v1610, sibType11-v1610, sibType12-v1610, sibType13-v1610, and sibType14-v1610.

In addition, the SIB type may be a positioning SIB type. Table 16 below shows the mapping relationship between positioning SIB types and assistance data elements. Details thereof be found in TS 37.355.

TABLE 16

| | posSibType | assistanceDataElement |
|---|---|---|
| GNSS Common Assistance | posSibType1-1 | GNSS-ReferenceTime |
| Data (clause 6.5.2.2) | posSibType1-2 | GNSS-ReferenceLocation |
| | posSibType1-3 | GNSS-IonosphericModel |
| | posSibType1-4 | GNSS-EarthOrientationParameters |
| | posSibType1-5 | GNSS-RTK-ReferenceStationInfo |
| | posSibType1-6 | GNSS-RTK-CommonObservationInfo |
| | posSibType1-7 | GNSS-RTK-AuxiliaryStationData |
| | posSibType1-8 | GNSS-SSR-CorrectionPoints |
| GNSS Generic Assistance | posSibType2-1 | GNSS-TimeModelList |
| Data (clause 6.5.2.2) | posSibType2-2 | GNSS-DifferentialCorrections |
| | posSibType2-3 | GNSS-NavigationModel |
| | posSibType2-4 | GNSS-RealTimeIntegrity |
| | posSibType2-5 | GNSS-DataBitAssistance |
| | posSibType2-6 | GNSS-AcquisitionAssistance |
| | posSibType2-7 | GNSS-Almanac |
| | posSibType2-8 | GNSS-UTC-Model |
| | posSibType2-9 | GNSS-AuxiliaryInformation |
| | posSibType2-10 | BDS-DifferentialCorrections |
| | posSibType2-11 | BDS-GridModelParameter |
| | posSibType2-12 | GNSS-RTK-Observations |
| | posSibType2-13 | GLO-RTK-BiasInformation |
| | posSibType2-14 | GNSS-RTK-MAC-CorrectionDifferences |
| | posSibType2-15 | GNSS-RTK-Residuals |
| | posSibType2-16 | GNSS-RTK-FKP-Gradients |
| | posSibType2-17 | GNSS-SSR-OrbitCorrections |
| | posSibType2-18 | GNSS-SSR-ClockCorrections |
| | posSibType2-19 | GNSS-SSR-CodeBias |
| | posSibType2-20 | GNSS-SSR-URA |
| | posSibType2-21 | GNSS-SSR-PhaseBias |
| | posSibType2-22 | GNSS-SSR-STEC-Correction |
| | posSibType2-23 | GNSS-SSR-GriddedCorrection |
| | posSibType2-24 | NavlC-DifferentialCorrections |
| | posSibType2-25 | NavlC-GridModelParameter |
| OTDOA Assistance Data | posSibType3-1 | OTDOA-UE-Assisted |
| (clause 7.4.2) | | |
| Barometric Assistance Data | posSibType4-1 | Sensor-AssistanceDataList |
| (clause 6.5.5.8) | | |
| TBS Assistance Data | posSibType5-1 | TBS-AssistanceDataList |
| (clause 6.5.4.8) | | |
| NR DL-TDOA/DL-AoD | posSibType6-1 | NR-DL-PRS-AssistanceData |
| Assistance Data (clauses | posSibType6-2 | NR-UEB-TRP-LocationData |
| 6.4.3, 7.4.2) | posSibType6-3 | NR-UEB-TRP-RTD-Info |

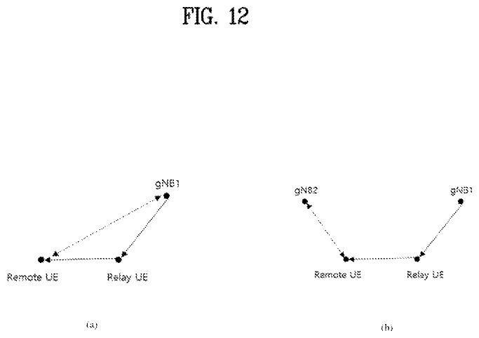

As described above, the remote UE may perform different operations in the following cases: when the remote UE exists in coverage where the remote UE is capable of directly receiving signals from the camping cell (or serving cell); and when the remote UE is not in coverage where the remote UE is capable of directly receiving signals from the camping cell (or serving cell) (and/or when the remote UE exists in the coverage of another cell). Hereinafter, each case will be described with reference to FIG. 12.

FIG. 12(a) shows a case where the remote UE exists in coverage where the remote UE is capable of directly receiving signals from the camping cell (or serving cell). In exceptional cases, the remote UE may request an on-demand SIB directly from the gNB only when the remote UE requires an SIB that the relay UE is incapable of transmitting (because the relay UE has no capability to perform decoding). Alternatively, the remote UE may directly decode the SIB based on SIB1 information received from the relay UE.

For example, when the remote UE requires a positioning-related SIB, but the relay UE does not support the position SIB (or when the remote UE requests the positioning-related SIB from the relay UE, but the relay UE declines the request due to capability reasons), the remote UE may directly request the on-demand SIB from the gNB.

Alternatively, when the remote UE requires an SIB and/or service related to MBMS, but the relay UE is incapable of supporting the SIB and/or service related to MBMS (or when the remote UE requests the SIB and service related to MBMS from the relay UE, but the relay UE declines the request due to capability reasons), the remote UE may receive the SIB and/or service related to MBMS directly from the gNB.

Alternatively, when the remote UE has a higher release version than the relay UE, the remote UE may request/receive an SIB capable of being supported only in higher release version directly from the gNB.

As another example, the remote UE may transmit a code point corresponding to the SIB type (e.g., the location of a resource where the SIB is transmitted). The relay UE may use the code point to identify an SIB message containing the corresponding SIB and transmit the SIB message to the remote UE without decoding the message (by dumping either the whole message or bits corresponding to the code point).

As a further example, when relay UEs forward SIBs before establishing a PC5-S (or PC5-RRC) connection with the remote UE (the relay UEs may decode all possible SIBs received from the gNB and broadcast/groupcast the SIBs), the remote UE may preferentially select a relay UE that transmits an SIB that the remote UE desires (requires). In this case, since the relay UE has not established the connection with the remote UE, the relay UE may only transmit the types of SIBs that the relay UE is capable of forwarding. The SIB types that the relay UEs is capable of forwarding may be included in a discovery message.

FIG. 12(a) shows a case where the remote UE is not in coverage where the remote UE is capable of directly receiving signals from the camping cell (or serving cell) and/or the remote UE exists in the coverage of another cell.

In FIG. 12(b), the remote UE may perform relay reselection as described above. Alternatively, the remote UE may request an on-demand SIB directly from the gNB. That is, the remote UE may exceptionally request the on-demand SIB directly from the gNB only when the remote UE requires an SIB that the relay UE is incapable of transmitting. In this case, the remote UE may operate in different ways depending on the type of desired SIB.

For example, when the remote UE requires a positioning-related SIB, the remote UE may request related SIB information from a gNB/TRP (transmission-reception point) that provides the best RSRP, which is measured by the remote UE, and then perform positioning by establishing a connection with the corresponding gNB. Similarly, in the case of MBMS, if the relay UE has no related capability, the remote UE may receive related information directly. In other words, the remote UE may perform relay-related operations through the relay UE but, exceptionally, the remote UE may be limited such that the remote UE transmits/receives desired services through a direct link for operations that the relay UE is incapable of supporting.

Regarding the context described above, a remote UE in a wireless communication system may include: at least one processor; and at least one computer memory operably connected to the at least one processor and configured to store instructions that, when executed, cause the at least one processor to perform operations. The operations may include: selecting a plurality of candidate relay UEs; selecting one relay UE among the plurality of candidate relay UEs based on measurement results; establishing an SL connection with the relay UE; and transmitting a SIB-related request including an SIB type to the relay UE. Based on that the SIB type is beyond a capability of the relay UE, the remote UE may receive a message related to inability to support the SIB type from the relay UE.

In addition, there is provided a processor configured to perform operations for a remote UE. The operations may include: selecting a plurality of candidate relay UEs; selecting one relay UE among the plurality of candidate relay UEs based on measurement results; establishing an SL connection with the relay UE; and transmitting a SIB-related request including an SIB type to the relay UE. Based on that the SIB type is beyond a capability of the relay UE, the remote UE may receive a message related to inability to support the SIB type from the relay UE.

Further, there is provided a non-volatile computer-readable storage medium configured to store at least one computer program including instructions that, when executed by at least one processor, cause the at least one processor to perform operations for a remote UE. The operations may include: selecting a plurality of candidate relay UEs; selecting one relay UE among the plurality of candidate relay UEs based on measurement results; establishing an SL connection with the relay UE; and transmitting a SIB-related request including an SIB type to the relay UE. Based on that the SIB type is beyond a capability of the relay UE, the remote UE may receive a message related to inability to support the SIB type from the relay UE.

### Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

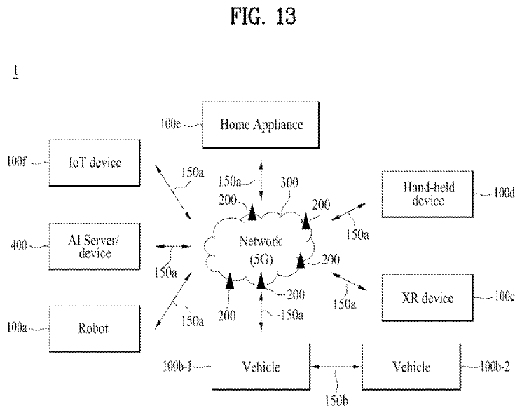

FIG. 13 illustrates a communication system 1 applied to the present disclosure.

Referring to FIG. 13, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g., relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices Applicable to the Present Disclosure

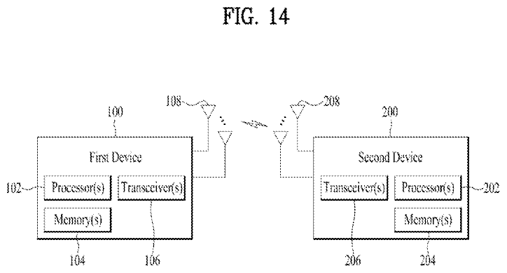

FIG. 14 illustrates wireless devices applicable to the present disclosure.

Referring to FIG. 14, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 13.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### Examples of a Vehicle or an Autonomous Driving Vehicle Applicable to the Present Disclosure

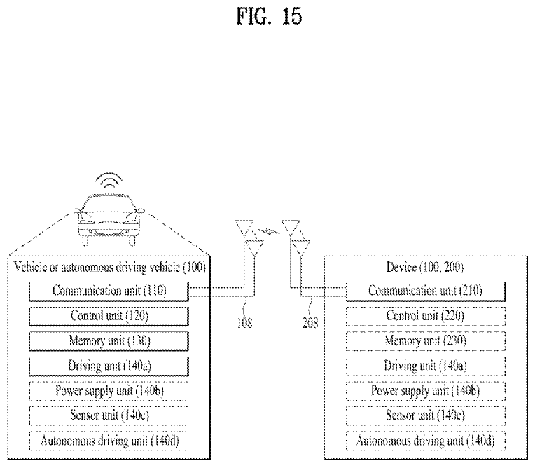

FIG. 15 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 15, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

### Examples of a Vehicle and AR/VR Applicable to the Present Disclosure

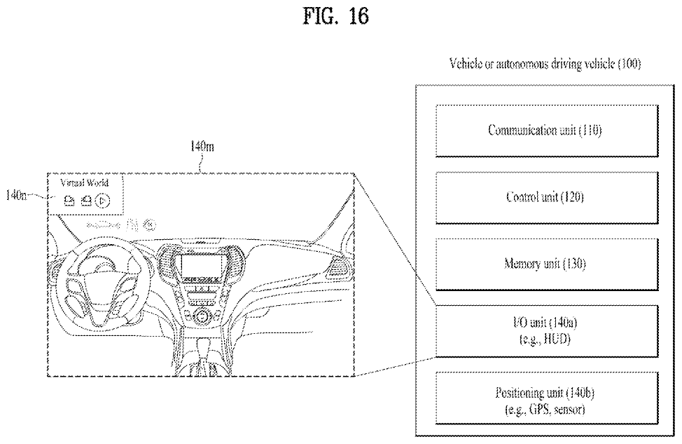

FIG. 16 illustrates a vehicle applied to the present disclosure. The vehicle may be implemented as a transport means, an aerial vehicle, a ship, etc.

Referring to FIG. 16, a vehicle 100 may include a communication unit 110, a control unit 120, a memory unit 130, an I/O unit 140a, and a positioning unit 140b.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

### Examples of an XR Device Applicable to the Present Disclosure

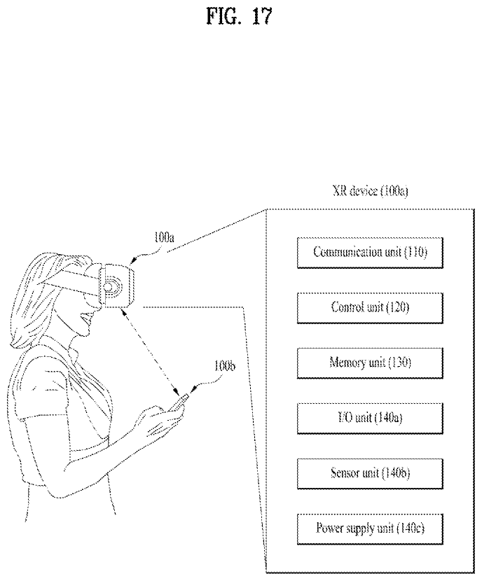

FIG. 17 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 17, an XR device 100a may include a communication unit 110, a control unit 120, a memory unit 130, an I/O unit 140a, a sensor unit 140b, and a power supply unit 140c.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

### Examples of a Robot Applicable to the Present Disclosure

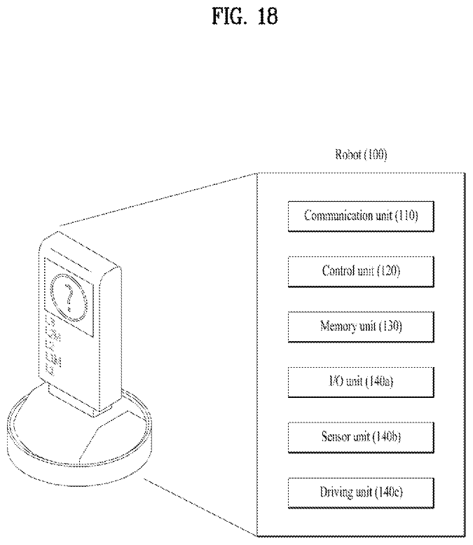

FIG. 18 illustrates a robot applied to the present disclosure. The robot may be categorized into an industrial robot, a medical robot, a household robot, a military robot, etc., according to a used purpose or field.

Referring to FIG. 18, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 14, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

Example of AI device to which the present disclosure is applied.

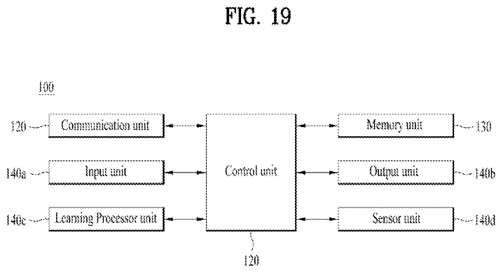

FIG. 19 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 19, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 14, respectively.

The communication unit 110 may transmit and receive wired/radio signals (e.g., sensor information, user input, learning models, or control signals) to and from external devices such as other AI devices (e.g., 100x, 200, or 400 of FIG. 13) or an AI server (e.g., 400 of FIG. 13) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 13). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 13). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

### INDUSTRIAL APPLICABILITY

The above-described embodiments of the present disclosure are applicable to various mobile communication systems.

1. A method of operating a remote user equipment (UE) in a wireless communication system, the method comprising:
selecting, by the remote UE, a plurality of candidate relay UEs;
selecting, by the remote UE, one relay UE among the plurality of candidate relay UEs based on measurement results;
establishing, by the remote UE, a sidelink connection with the relay UE; and
transmitting, by the remote UE, a system information block related (SIB-related) request including an SIB type to the relay UE,
wherein based on that the SIB type is beyond a capability of the relay UE, the remote UE receives a message related to inability to support the SIB type from the relay UE.

2. The method of claim 1, wherein based on the reception of the message related to the inability to support the SIB type, the remote UE performs either relay reselection or SIB reception from a base station (BS), depending on whether the remote UE is located in coverage of a serving cell.

3. The method of claim 1, wherein based on that the remote UE is located out of coverage of a serving cell, the remote UE performs relay reselection.

4. The method of claim 1, wherein based on that the remote UE is located in coverage of a serving cell, the remote UE directly receives an SIB corresponding to the SIB-related request from a base station (BS).

5. The method of claim 1, wherein a serving cell of the remote UE corresponds to a serving cell of the relay UE.

6. The method of claim 1, wherein the remote UE obtains the capability of the relay UE from a discovery message transmitted by the relay UE.

7. The method of claim 1, wherein the inability to support the SIB type is based on that the capability of the relay UE is different from a capability of the remote UE.

8. The method of claim 7, wherein the SIB type beyond the capability of the relay UE corresponds to one of the following cases:
the remote UE is capable of supporting multimedia broadcast multicast services (MBMS), but the relay UE is incapable of supporting the MBMS;
the remote UE is capable of supporting positioning services, but the relay UE is incapable of supporting the positioning services; and
the remote UE has a standard specification release version higher than the relay UE.

9. The method of claim 1, wherein the SIB type corresponds to one of positioning SIB types.

10. A remote user equipment (UE) in a wireless communication system, the remote UE comprising:
at least one processor; and
at least one computer memory operably connected to the at least one processor and configured to store instructions that, when executed, cause the at least one processor to perform operations comprising:
selecting a plurality of candidate relay UEs;
selecting one relay UE among the plurality of candidate relay UEs based on measurement results;
establishing a sidelink connection with the relay UE; and
transmitting a system information block related (SIB-related) request including an SIB type to the relay UE,
wherein based on that the SIB type is beyond a capability of the relay UE, the remote UE receives a message related to inability to support the SIB type from the relay UE.

11. The remote UE of claim 10, wherein the remote UE communicates with at least one of another UE, a UE related to an autonomous vehicle, a base station (BS), or a network.

12. A processor configured to perform operations for a relay remote user equipment (UE) in a wireless communication system, the operations comprising:
selecting a plurality of candidate relay UEs;
selecting one relay UE among the plurality of candidate relay UEs based on measurement results;
establishing a sidelink connection with the relay UE; and
transmitting a system information block related (SIB-related) request including an SIB type to the relay UE,
wherein based on that the SIB type is beyond a capability of the relay UE, the remote UE receives a message related to inability to support the SIB type from the relay UE.

13. A non-volatile computer-readable storage medium configured to store at least one computer program comprising instructions that, when executed by at least one processor, cause the at least one processor to perform operations for a remote user equipment (UE), the operations comprising:
selecting a plurality of candidate relay UEs;
selecting one relay UE among the plurality of candidate relay UEs based on measurement results;
establishing a sidelink connection with the relay UE; and
transmitting a system information block related (SIB-related) request including an SIB type to the relay UE,
wherein based on that the SIB type is beyond a capability of the relay UE, the remote UE receives a message related to inability to support the SIB type from the relay UE.
